(19) United States
(12) Patent Application Publication
(10) Pub. No.: US 2014/0061427 A1
(43) Pub. Date: Mar. 6, 2014

(54) COMBINED PAD STRUCTURE

(71) Applicant: PI-CHAO CHANG, Taichung City (TW)

(72) Inventor: PI-CHAO CHANG, Taichung City (TW)

(21) Appl. No.: 13/604,650

(22) Filed: Sep. 6, 2012

(51) Int. Cl. A47J 43/18; B23Q 3/00; A47G 23/00; F16M 11/02; F16M 11/00

(52) U.S. Cl. 248/558; 248/349.1; 269/19

(57) ABSTRACT

A combined pad structure contains a disc base and a body. The disc base includes an anti-slid area defined on a bottom end thereof. The body includes a circular groove defined on a bottom end thereof to receive the disc base and includes a limiting portion formed on four corners of the bottom end thereof. Thereby, when the body is placed onto the disc base, the disc base is limited in the circular groove of the body, hence the body allows being rotated along the disc base. Also, when the body disengages from the disc base, they allow being used respectively, thus increasing using functions.

### FIELD OF THE INVENTION

The present invention relates to a combined pad structure which has a disc base and a body, both of which are used solely or together.

### BACKGROUND OF THE INVENTION

As shown in FIGS. 1-4, a conventional pad structure contains an upper pad 10 and a lower pad 11. The lower pad 11 has an axial hole 12 defined on a central position thereof so as to correspond to a post 13 extending from a bottom end of the upper pad 10. In operation, the upper pad 10 is connected with the lower pad 11 by inserting the post 13 into the axial hole 12, such that the lower pad 11 allows being used as a rotary base so that the upper pad 10 is rotated on the lower pad 11 along the post 13.

However, such a conventional pad structure still has the following defects:

1. When a workpiece is located at different angles, the pad structure is rotated based on using requirement, but the same overlapping area generates between the upper pad 10 and the lower pad 11, so the upper pad 10 drives the lower pad 11 to move together, thus causing using inconvenience.

2. If the upper pad 10 disengages from the lower pad 11, they can not be used solely.

The present invention has arisen to mitigate and/or obviate the afore-described disadvantages.

### SUMMARY OF THE INVENTION

The primary object of the present invention is to provide a combined pad structure which has a disc base and a body, both of which are used solely or together.

Another object of the present invention is to provide a combined pad structure which has multi-functions. For example, the disc body and the body are used to cut a workpiece or to align with the workpiece by ways of two marking lines marked on the two top surfaces of the body and the disc base.

To obtain the above objectives, combined pad structure contains:

a disc base and a body. The disc base includes an anti-slid area defined on a bottom end thereof. The body includes a circular groove defined on a bottom end thereof to receive the disc base and a limiting portion formed on four corners of the bottom end thereof; Thereby, when the body is placed onto the disc base, the disc base is limited in the circular groove of the body, hence the body allows being rotated along the disc base.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the assembly of a conventional pad structure.

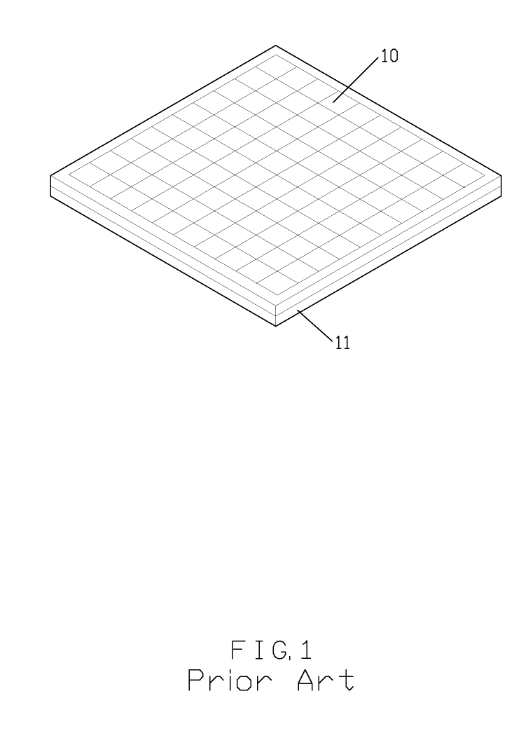

FIG. 2 is a perspective view of the exploded components of the conventional pad structure.

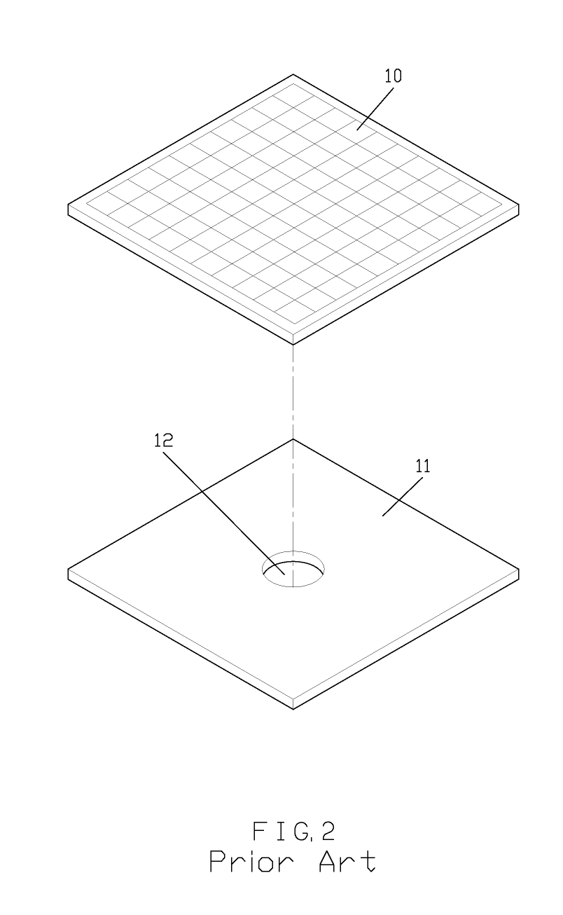

FIG. 3 is another perspective view of the exploded components of the conventional pad structure.

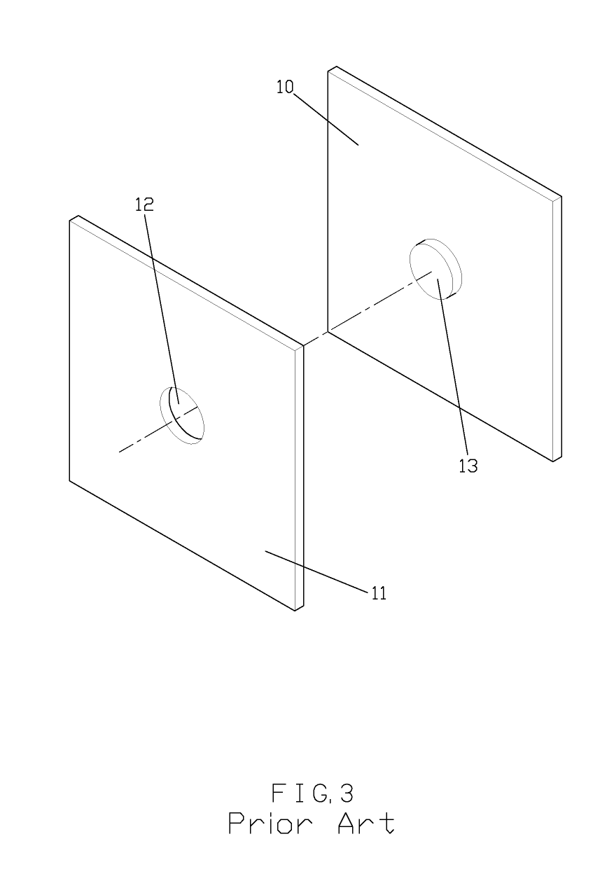

FIG. 4 is a perspective view of the operation of the conventional pad structure.

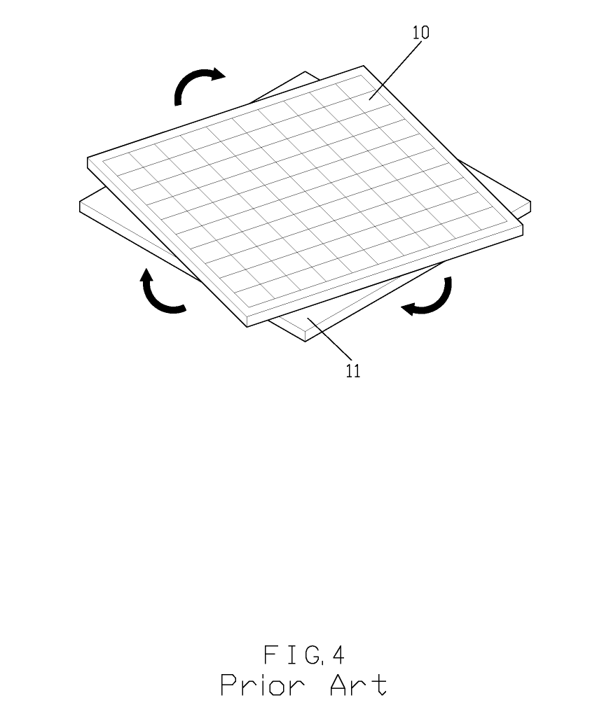

FIG. 5 is a perspective view showing the assembly of a combined pas structure according to a preferred embodiment of the present invention.

FIG. 6 is a perspective view showing the exploded components of the combined pas structure according to the preferred embodiment of the present invention.

FIG. 7 is another perspective view showing the exploded components of the combined pas structure according to the preferred embodiment of the present invention.

FIG. 8 is a side plan view showing the operation of the combined pas structure according to the preferred embodiment of the present invention.

FIG. 9 is a perspective view showing the operation of the combined pas structure according to the preferred embodiment of the present invention.

FIG. 10 is another perspective view showing the operation of the combined pas structure according to the preferred embodiment of the present invention.

FIG. 11 is a perspective view showing the exploded components of a combined pas structure according to another preferred embodiment of the present invention.

### DETAILED DESCRIPTION OF THE PREFERRED EMBODIMENTS

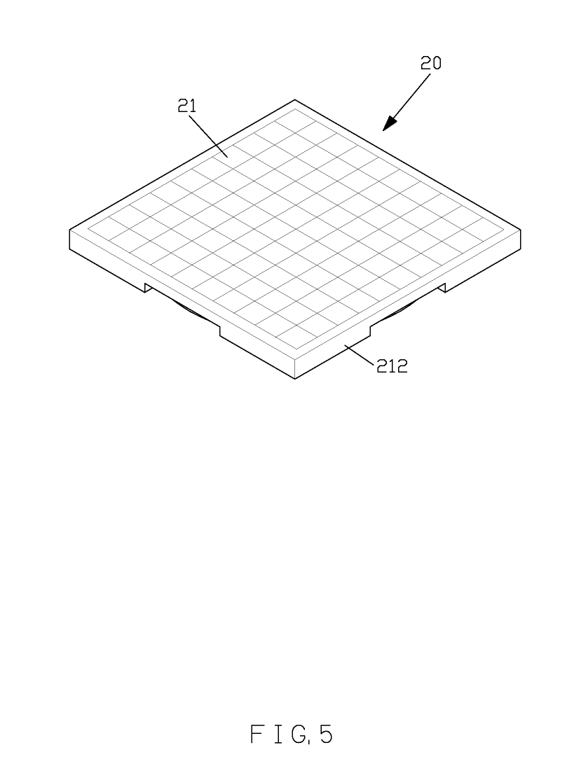

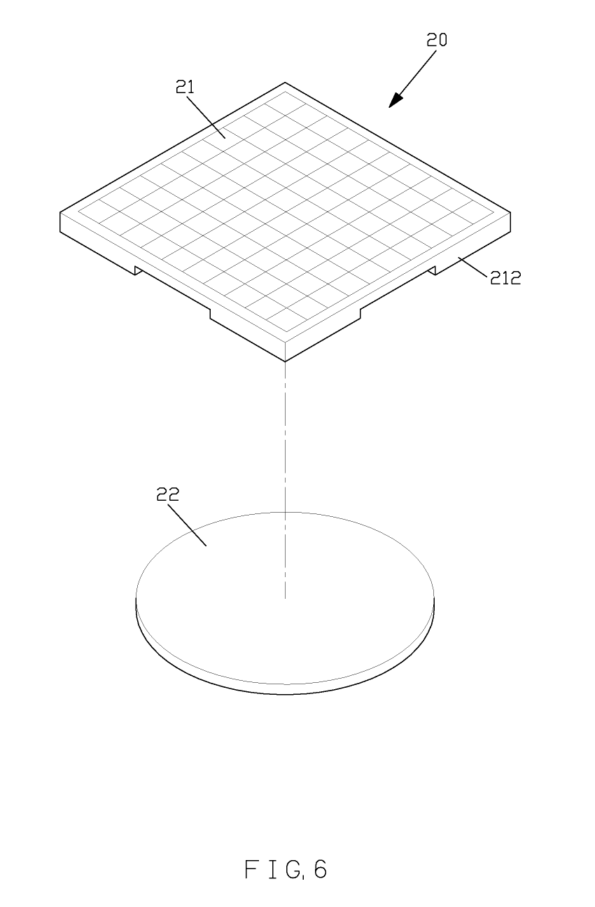

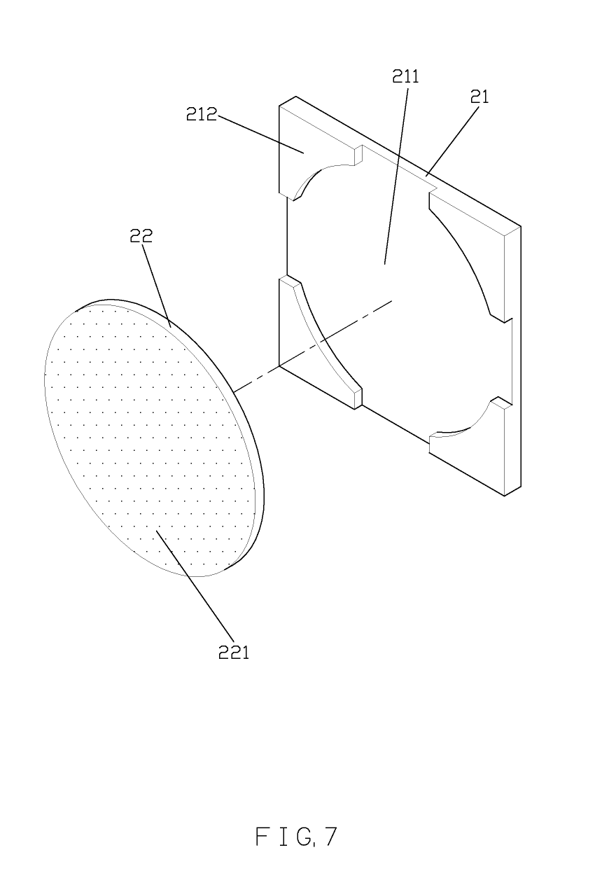

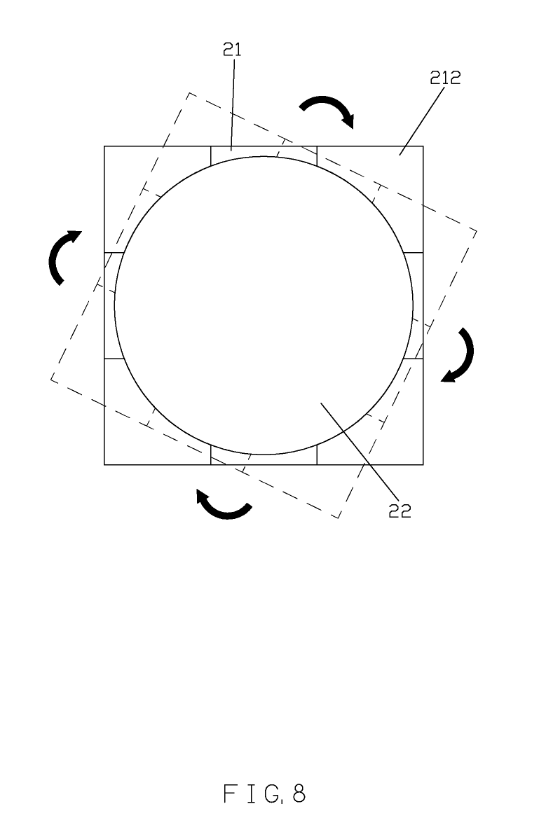

Referring to FIGS. 5-8, a combined pad structure 20 according to a preferred embodiment of the present invention comprises: a disc base 22 and a body 21. The disc base 22 includes an anti-slid area 221 defined on a bottom end thereof. The body 21 includes a circular groove 211 defined on a bottom end thereof to receive the disc base 22 and includes a limiting portion 212 formed on four corners of the bottom end thereof, such that when the body 21 is placed onto the disc base 22, the disc base 22 is limited in the circular groove 211 of the body 21, hence the body 21 allows being rotated along the disc base 22.

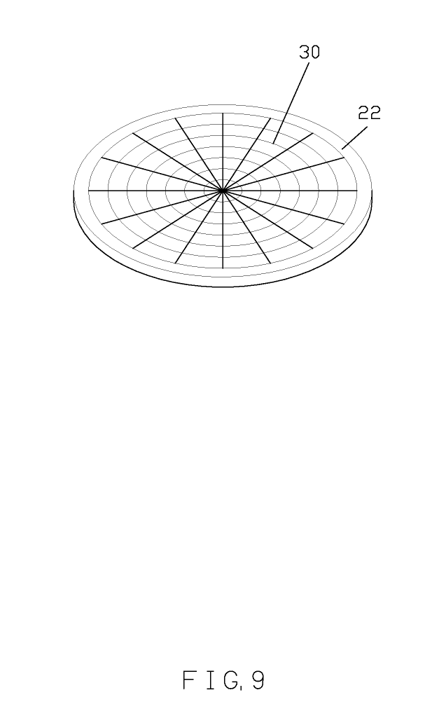

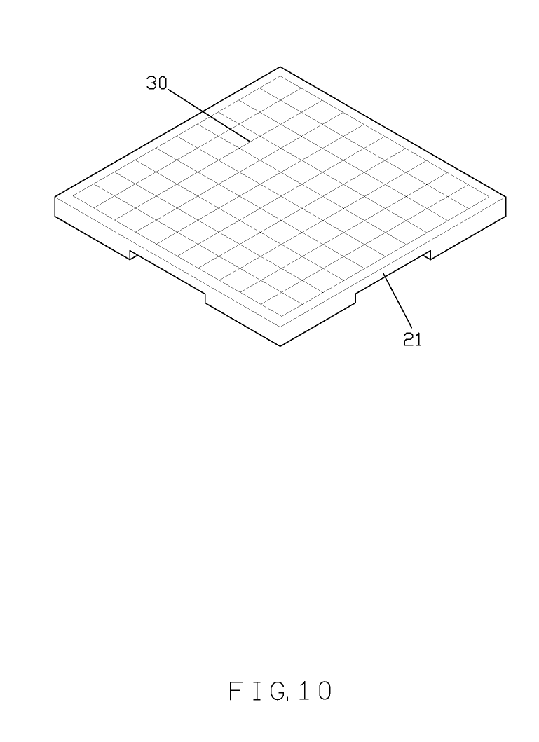

Referring further to FIGS. 9 and 10, when the body 21 disengages from the disc base 22, the body 21 and the disc base 22 have two using areas defined on two top surfaces thereof and two flat bottom surfaces so as to place the body 21 and the disc base 22 securely, hence two using areas of the body 21 and the disc base 22 are applicable for different usages. For example, they are used to cut a workpiece respectively or to align with the workpiece by ways of two marking lines 30 marked on the two top surfaces of the body 21 and the disc base 22.

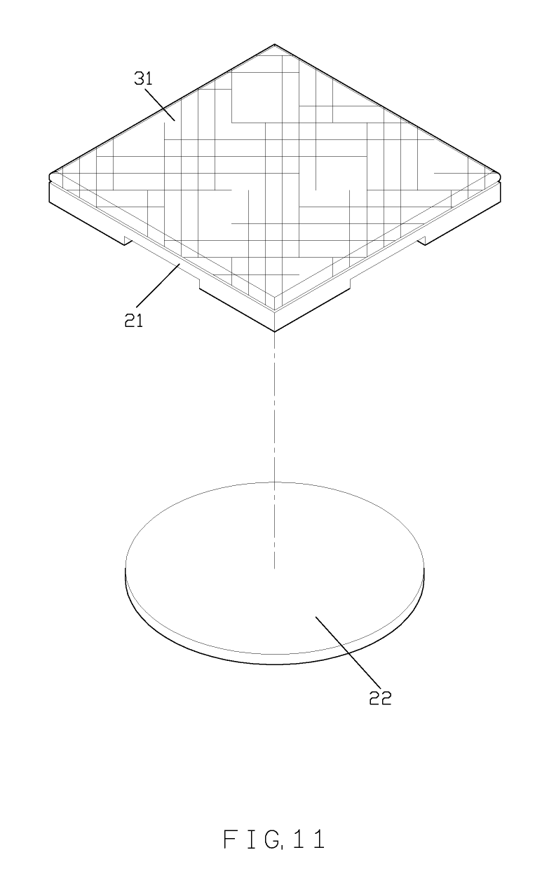

As shown in FIGS. 10 and 11, after the body 21 is combined with the disc base 22, a cloth pad 31 is attached on a top surface of the body 21 so that the body 21 forms a rotatable hot plate, thus increasing using function.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A combined pad structure comprising:
a disc base including an anti-slid area defined on a bottom end thereof;
a body including a circular groove defined on a bottom end thereof to receive the disc base and including a limiting portion formed on four corners of the bottom end thereof;
such that when the body is placed onto the disc base, the disc base is limited in the circular groove of the body, hence the body allows being rotated along the disc base.

2. The combined pad structure as claimed in claim 1, wherein the body and the disc base have two using areas defined on two top surfaces thereof and two flat bottom surfaces so as to place the body and the disc base securely.

3. The combined pad structure as claimed in claim 2, wherein the two using areas of the body and the disc base are applicable for different usages.

4. The combined pad structure as claimed in claim 1, wherein the body and the disc base have two marking lines marked on the two top surfaces so as to align with a workpiece.

5. The combined pad structure as claimed in claim 1, wherein the body has a cloth pad attached on a top surface thereof.
